(19) United States
(12) Patent Application Publication
(10) Pub. No.: US 2016/0078481 A1
(43) Pub. Date: Mar. 17, 2016

(54) Process to Administer Mandatory Restrictions or Accede to User Preferences in a Distributed, Real-Time Market for Advertising to Mobile and Personal Devices

(71) Applicants: Shane Holland, San Francisco, CA (US); Charles Marshall, Atherton, CA (US); Donald Henry, Menlo Park, CA (US)

(72) Inventors: Shane Holland, San Francisco, CA (US); Charles Marshall, Atherton, CA (US); Donald Henry, Menlo Park, CA (US)

(73) Assignee: DONOTGEOTRACK, INC., Atherton, CA (US)

(21) Appl. No.: 14/476,201

(22) Filed: Sep. 16, 2014

(51) Int. Cl. G06Q 30/02

(52) U.S. Cl. CPC G06Q 30/0257; G06Q 30/0267

(57) ABSTRACT

Laws, regulations, and self-regulatory processes are beginning to restrict how online advertisers and others interact with users. The Children's Online Privacy Protection Act of 1998 (COPPA) restricts the interaction of online businesses with children under thirteen.

Revised regulations implementing this statute will restrict behavioral advertising by businesses directed to children and by other business if they have actual knowledge they are dealing with a child under thirteen. The current system of ad placement online relies on a real-time, distributed market where participants usually interact at arms-length through intermediaries (usually online advertising networks) in placing ads. There is currently no process by which COPPA regulations or possible future regulatory or self-regulatory frameworks can be imposed on this system requiring abandonment of the system or processes which can work consistent with the system when used on a mobile or personal device. The disclosure provides a method by which the current system can be retained with minor modification by creating, populating, maintaining, and making available in near real time an opt-out registry that links unique persistent identifiers for mobile and personal devices to restrictions, preferences, and permissions related to such devices. The disclosure also described the integrated and complementary technology that needs to be deployed to support the method.

### CROSS REFERENCE TO RELATED APPLICATIONS

The present application relates to and claims priority of U.S. provisional patent application (“Copending Provisional Application”), Ser. No. 61/808,504, entitled “A PROCESS TO ADMINISTER MANDATORY RESTRICTIONS OR ACCEDE TO USER PREFERENCES IN A DISTRIBUTED, REAL-TIME MARKET FOR ADVERTISING TO MOBILE AND PERSONAL DEVICES,” filed on Jun. 27, 2013. The disclosure of the Copending Provisional Application is hereby incorporated by reference in its entirety.

### BACKGROUND OF THE INVENTION

1. Field of Invention

The present application relates to administering a mandatory restrictions¹ or acceding to user preferences in the distributed, real-time market for advertising to mobile and personal devices. This process would help advertisers,² publishers,³ and intermediaries⁴ to comply with such restrictions and preferences within the structure of the current market for advertising. Although the legal environment in this area is evolving and advertisers and publishers are seeking ways to respect user preferences, The Children's Online Privacy Protection Act of 1998 (COPPA)⁵ and revised Federal Trade Commission regulations⁶ scheduled to take effect on Jul. 1, 2013 largely forbid behavioral advertising through online businesses directed to children and by other businesses when they have actual knowledge they are dealing with such a child under thirteen. ¹ Such restrictions might be statutory, regulatory, or contractual.² Advertisers are those with content they wish to have delivered to mobile and personal device users.³ Publishers are those with websites, games, or other activities in which advertising content may be displayed.⁴ Intermediaries is used here to describe those who match up those wishing to display advertising with those who have a place where such advertising can be displayed and those who handle the financial transactions between these parties. Such intermediaries include ad networks and advertising agencies which deal in online content. In some cases, advertisers, publishers, or other actors in this system may play the role of intermediary in addition to their own role. For example, a major publisher may act as its own ad network for its own ad space whether or not it acts in such a capacity for other publishers. An advertiser may act similarly.⁵ 5 USC 6501-6506⁶ 16 CFR Part 312.

2. Discussion of the Related Art

Mobile devices, especially smart phones and tablets, have become ubiquitous in recent years. Laptop computers and game consoles are similarly widespread. These devices provide many educational, productivity, and social services to their users; they also introduce many unforeseen risks to personal privacy of these users. Much of the functionality of mobile and personal devices comes from apps, web sites, and other services usually offered for free to users. App developers, site publishers, and other service providers are usually compensated through advertising revenue generated by ads linked to their products. A recent academic article visually described this complex market as is shown in FIG. 1.

Smart phones and to a lesser extent tablets are truly personal devices: they are generally used by one person, and that person usually has such a device with him or her at most times. Often laptop computers and game consoles are similarly personal. While online privacy issues go beyond these sorts of devices, these devices present particular problems (all information placed on, flowing through, or generated by⁷ such a device can be attributed to one person and compiling and linking such information may disclose an uncomfortable level of detail about that person). These devices also provide opportunities (restrictions on collecting, using, and transferring such information on a person can be translated to restrictions particular to the device). Geo-locating information, for example, is created by many of these devices.

### SUMMARY OF THE INVENTION

This application discloses a process whereby online advertisers and publishers can continue to interact through largely arms-length, real-time markets while superimposing a structure of privacy protection or other restrictions on these transactions when they are directed to a mobile or personal device.

The core of the process is method linking persistent device identifiers to a user for whom there are mandatory or voluntary restrictions on the type of advertisement which can be provided and storing such links in a secure, fault-tolerant, distributed database.⁸ An ad network⁹ queries the database before serving ads to a device to learn what restrictions, if any, apply to the device before serving compliant ads to that device. ⁸ In the case of COPPA compliance for behavioral advertising, the database would relate persistent identifiers for devices belonging to children under thirteen to a restriction on behavioral advertising.⁹ Or other entity such as an advertiser or publisher acting as such.

Because legal responsibility to comply with mandatory restrictions and interests in voluntarily acceding to expressed preferences rest with many parties, a number of parties need to be able to add restriction data to the database. In the impending and illustrative example of behavioral advertising to children, publishers and advertisers both have responsibilities when the publisher is a business directed to children or either the advertiser or publisher have actual knowledge the user is under thirteen. Parents may also inform potential publishers and advertisers that a device belongs to a COPPA covered child. Standardized software development kits (SDKs) would be made available to advertisers and publishers to allow opting out of certain types of advertising. Downloadable apps for mobile devices would allow parents in the COPPA case or device users or owners in other cases to register the device with their intended restrictions.

To remain compliant with the mandatory restrictions or voluntary preferences, advertisers and publishers would need to restrict their transactions to those ad networks which query the database before completing each transaction. For the advertiser or publisher, the database would include all devices and accompanying restrictions they themselves have registered as well as those registered by other businesses and parents, users, or owners. As long as a business (whether an advertiser or publisher) registers all devices and restrictions for notifications or knowledge it has received, it should be in compliance with these restrictions for any ad placed by a participating ad network.

### BRIEF DESCRIPTION OF THE DRAWINGS

FIG. 1 provides a diagram of online advertising parties and relationships

FIG. 2 shows the logical links between device identifiers, devices, users, and restrictions, preferences, and permissions

FIG. 3 shows the logical links between device identifiers, devices, user/device pairs and restrictions, preferences, and permissions

FIG. 4 shows an overview of the disclosed process

FIG. 5 shows some sources of opt-out data within the disclosed process

FIG. 6 shows the integrated and complementary technology deployment to support the opt-out registry and its integration with near real time ad serving

FIG. 7 shows additions to opt-out registry from external sources

### DETAILED DESCRIPTION OF THE PREFERRED EMBODIMENTS

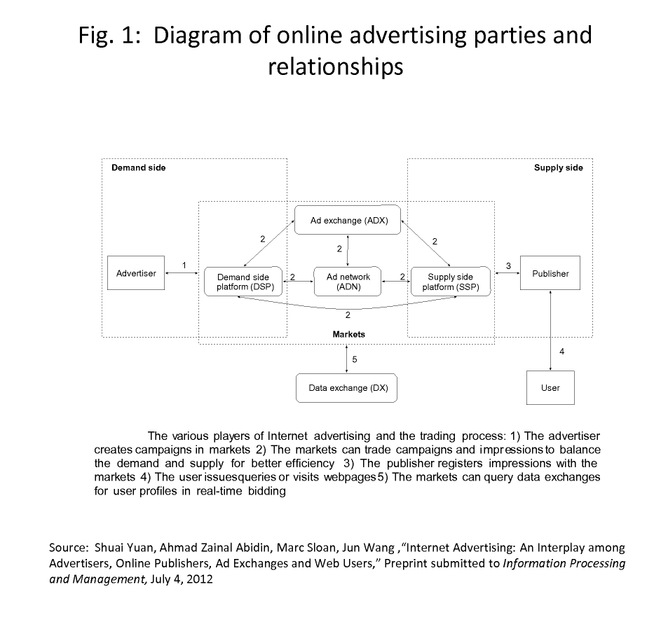

Parties involved in online advertising have legal responsibilities as well as commercial reasons to restrict advertising to certain users. Such legal responsibilities, for example, include obligations under the Children's Online Privacy Protection Act of 1998. Other legal obligations may be imposed in the future through statute, regulation, or self-regulatory programs. Businesses may wish to allow users or device owners (or parents in the case of COPPA) to express preferences to opt out of certain types of advertising content. Compliance with both mandatory and voluntary restrictions are difficult with the current distributed, real-time, and often arms-length markets by which various types of advertising content is placed with specific publishers for users. FIG. 1 shows the complex interactions among the various parties in online ad placement. Often such placement is based on intermediaries such as ad networks (or others performing their function) collecting, compiling, and correlating information about specific users beforehand to more accurately target such advertisements. Any solution which allows advertisers and publishers to meet their legal obligations as well as impose their desire to comply with user preferences must work within this current distributed market system or require switching to a new, more centralized, controlled, and ultimately less efficient system. This disclosure describes a set of technology deployments and processes which would allow compliance within the current system for mobile and other personal devices.

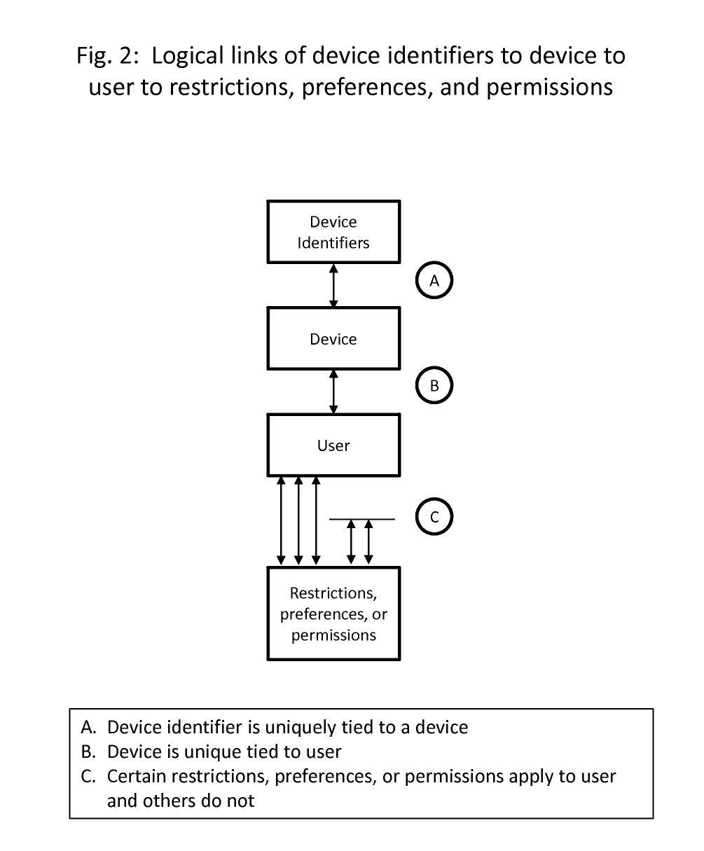

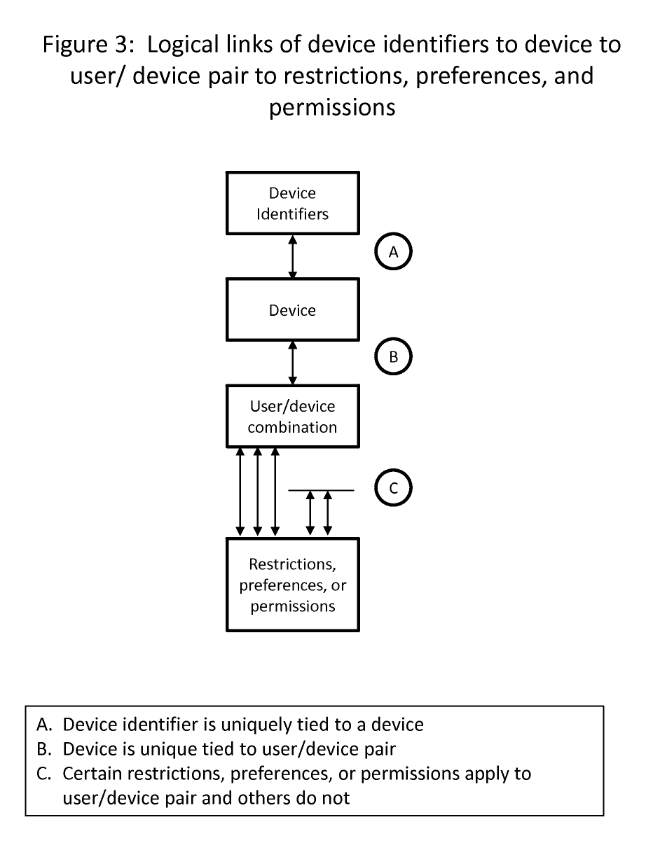

The core of the disclosed system is a secure online database which links unique, persistent mobile or personal device identifiers linked to specific restrictions, permissions, or preferences related to the user of the device.¹⁰ This database serves as an opt-out registry¹¹ which ties device identifiers which can be used by ad networks in near real time to restrictions, preferences, or permissions. The set of device identifiers would include any identifiers used by ad networks or others to target ads served to the device.¹² The ad network or other entity performing this function¹³ would query the database about what restrictions or permissions applied to the device and serve only ads consistent with such restrictions, ¹⁰ Alternatively, the restrictions, preferences, or permissions could apply to a certain user on of his or her devices.¹¹ The term “opt-out registry” is used to inclusively and may contain “opt-in” or permission type information as well as restrictions and opt-out preferences as the process described here is flexible enough to function in multiple (even simultaneously applicable) regulatory or self-regulatory environments.¹² These identifiers could include but are not limited to the cellular number, the Universal Device Identifier (UDID), the Advertising Identifier (IFA), MAC address, Open Device Identifier Number (ODIN), OpenUDID, TRUSTe ID, the Universally Unique Identifier (UUID), the Android ID, the device Internet Protocol (IP) address, VOIP identifier, video chat user identifier, the device serial number, or device linked account information, or other technical identifiers now in use or used in the future.¹³ An advertiser or publisher might act as an ad network for its own ads or ad space and may or may not perform such services for others. Future changes in this market may have others perform this function. For this disclosure, any entity which controls the flow of ad to a mobile or personal device might query the opt-out registry in the process of deciding which ads to serve. permissions, and preferences. The logical links between a device identifier and a restriction, preference, or permission can be seen in FIGS. 2 and 3. In the first case, the identifier corresponds uniquely to a device, which corresponds uniquely to a user, for whom there are certain restrictions, preferences, and permissions. In the second case, a user may have different preferences on different devices.¹⁴ ¹⁴ As an illustrative example, a parent might express a preference for no game applications on a child's cell phone which might be used unsupervised but might express a preference to allow game applications on a tablet device which that child normally uses under supervision.

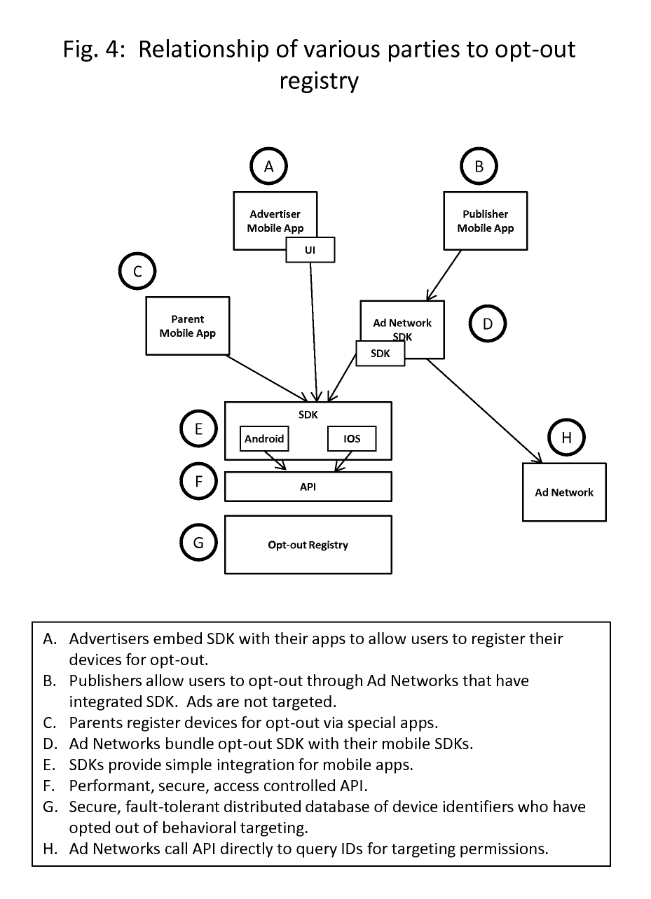

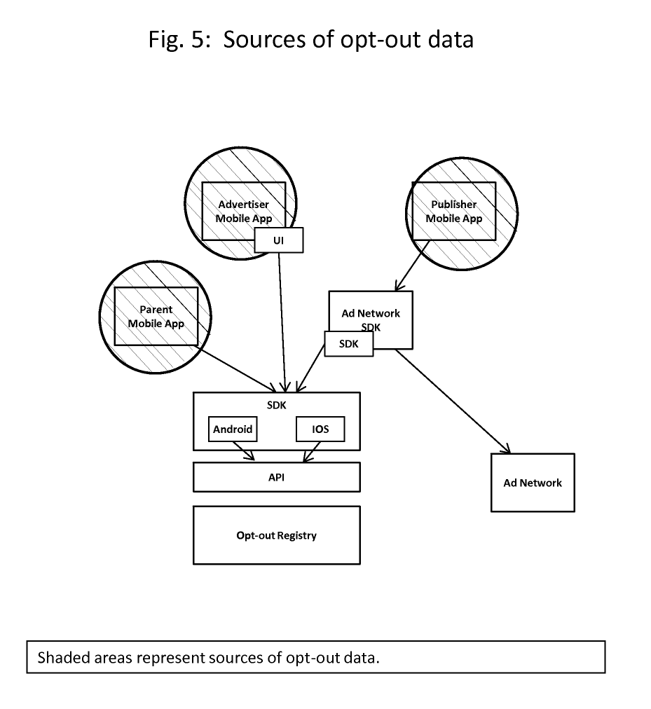

Because the specific case of COPPA imposes responsibilities on multiple parties in the ad serving process and such multiple-party responsibilities are likely to carry over to future regulatory and self-regulatory environments, an opt-out registry must be able to receive restriction, preference, and permission data through multiple channels. In the case of COPPA, a method for receiving such information from advertisers and publishers is necessary to ensure any party with responsibilities can document such responsibilities in the registry. Parents (in the COPPA case) or users or owners of devices need to be able to assert rights, express preferences, and grant permissions as well. FIG. 4 shows an overview of this process, and FIG. 5 highlights the sources of data collection matching device identifiers, devices, and users on the one hand and restrictions, preferences, and permissions on the other hand.

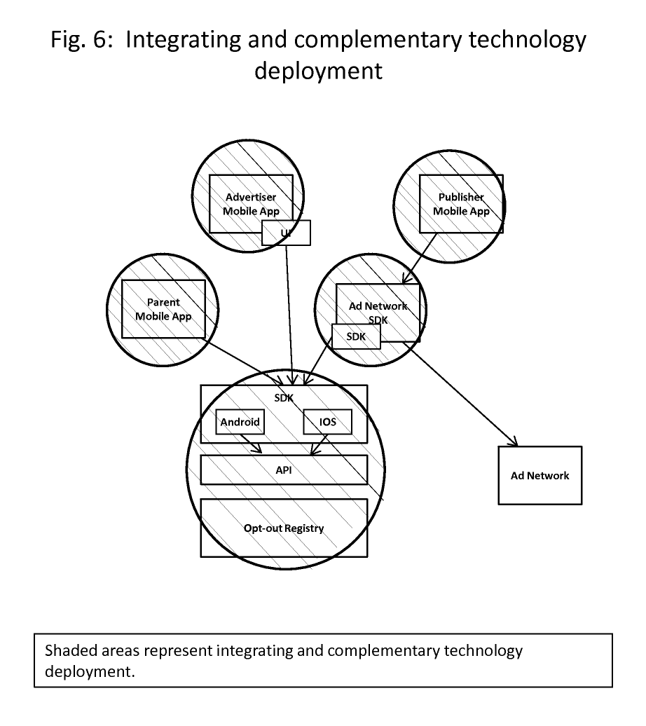

There are specific integrated and complementary technological deployments that are part of the overall process described here. FIG. 6 highlights these technological deployments. They include:
a) A mobile or personal device application or program which a parent (in the case of COPPA), user, or owner can download to a device to collect device identifiers from the device and accept (or begin to accept)¹⁵ restrictions, preferences, or permissions related to the device. ¹⁵ The application or program might begin a registration process that might be completed through other means such as a web portal.
b) An SDK (software development kit) which advertisers can use with their on-line apps to collect restrictions, preferences, or permissions related to a device.
c) An SDK which similarly allows publishers to collect restrictions, preferences, and permissions related to a device, on their online apps
d) SDKs for ad networks to bundle with their mobile device SDKs to ensure compatibility with the opt-out database
e) SDKs for others to include with their mobile and personal device apps

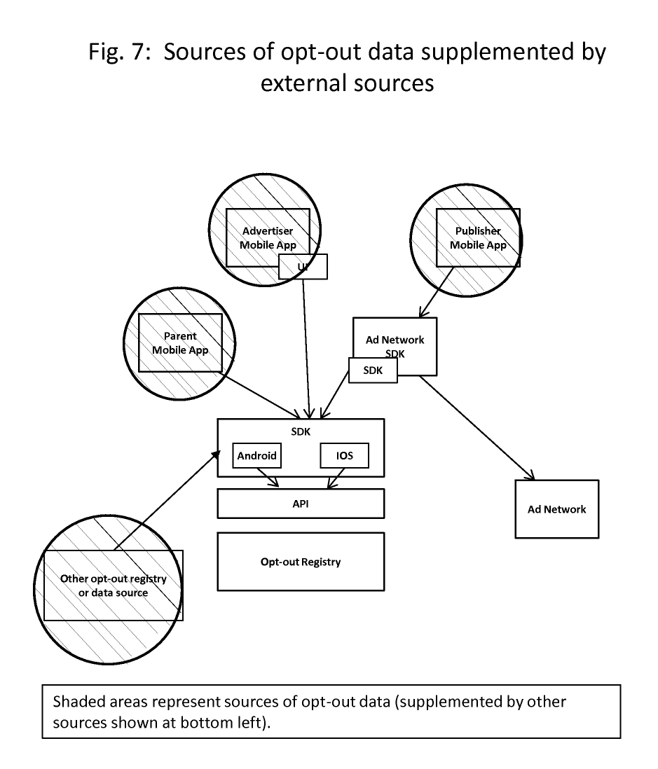

The downloadable apps and SDKs provide a means through which all participants in the online advertising business with regulatory and self-regulatory responsibilities can meet their responsibilities with regard to notification made directly by parents/users/owners through the downloadable app or gathered through the SDKs in their native environment. There may be cases where an online business learns of restrictions, preferences, or permissions through other means. These could be through registration in another opt-out registry, through information gleaned online from a method other than the apps and SDKs, or information obtained in other ways (for example, a parent writes a letter to a company notifying it that a particular device (with appropriate identifiers) is used by a child under 13. FIG. 7 shows how such information could be added to the opt-out registry through other means. One such source of information would be the mobile carrier or carrier's representative who could collect such information for the opt-out registry as part of enrolling for mobile services or when purchases, exchanging, servicing, or upgrading mobile or personal devices. Carriers could also collect such information as part of other interactions with a customer such as billing, notification of changes to terms and conditions, announcements of new or changing technologies, and so on. Such data could also be collected by other entities selling, distributing, or servicing mobile or personal devices as part of the sales, services, customer communications, or customer relations processes.

What is claimed is:

1. A method of linking unique persistent identifiers for mobile or personal devices to restrictions, preferences, or permissions related to the user of the device in an online registry:

2. A variation of claim 1 which links unique persistent identifiers for mobile or personal devices to restrictions, preferences, or permissions related to the user of the device while using that device in an online registry

3. The method of allowing online entities to use a mobile or personal device unique persistent identifier to query an online registry of restrictions, preferences, or permissions to determine prohibited, unwanted, or desired interactions with the device user through the device.

4. A specific embodiment of claim 3 wherein an online advertising networks (or those serving the same or similar functions where they are in a position to determine what sort of advertisement will be served to a particular device) to queries an online registry of restrictions, preferences, or permissions prior to serving an advertisement to a particular device

5. A specific embodiment of claim 3 wherein other online businesses query such an online registry before taking other actions with the user of the device pursuant to a regulatory or self-regulatory process including but not limited to collecting data from that user, collecting certain types of data from that user, allowing the user to participate in certain activities, allowing the user to download certain types of applications, or providing that user certain types of content (for example, sexually explicit or violent content).

6. A specific embodiment of claim 3 wherein a number of SDKs through which advertising networks or other businesses performing such roles or other online businesses can easily interact with the opt-out registry based on the device unique persistent identifiers common to the registry and the network's use.

7. The method of collecting and organizing information in an online opt-out registry wherein mobile and personal device unique persistent identifiers are linked to restrictions, preferences, and permissions for the user of the device.

8. A specific embodiment of claim 7 wherein information for the opt-out registry is collected through an application downloaded by the parent or device user or owner to the device to collect device identifiers and begin or complete assertion of restrictions, expression of preferences, and granting of permissions related to that user or related to that user on that device.

9. A specific embodiment of claim 7 wherein information for the opt-out registry is collected through software development kits (SDKs) available to advertisers and publishers of mobile device advertisements, and application developers which allow collection of restriction, preference, and permission data and linking such data to unique persistent identifiers of mobile or personal devices. The method further includes the automated transfer of such data to an opt-out registry.

10. A specific embodiment of claim 7 wherein information for the opt-out registry is collected from a mobile carrier or a mobile carrier's representative who collects such information as part of enrollment for services or during purchase, upgrade, servicing, or exchange of mobile or personal devices, or through a mobile carriers other interactions with a customer.

9. A specific embodiment of claim 7 wherein information for the opt-out registry is collected from other sellers, distributors, or servicers of mobile or personal devices during sales, distribution, servicing, customer communications, or customer service activities.
